(19) United States
(12) Patent Application Publication
(10) Pub. No.: US 2024/0154782 A1
(43) Pub. Date: May 9, 2024

(54) SYNCHRONIZING NETWORK REFERENCE TIME AMONG POWER LINE COMPONENTS

(71) Applicant: X Development LLC, Mountain View, CA (US)

(72) Inventors: Mike Miao He, Mountain View, CA (US); Rui Yao, San Jose, CA (US); Xinyue Li, San Mateo, CA (US); Leo Francis Casey, San Francisco, CA (US)

(21) Appl. No.: 17/981,193

(22) Filed: Nov. 4, 2022

(51) Int. Cl. H04L 7/00; H02J 13/00

(52) U.S. Cl. CPC H04L 7/0008; H02J 13/00002

(57) ABSTRACT

Methods, systems, and apparatus, including computer programs encoded on a computer storage medium, for performing electric grid timing coordination. The method can include: receiving, by a first electric grid device, a message from a second electric grid device, the message including a first clock value associated with an oscillator of the second electric grid device; determining, based on the first clock value, a second-first device time offset between the second electric grid device and the first electric grid device; and storing the second-first device time offset in a time offset table stored at the first electric grid device.

### TECHNICAL FIELD

The present specification relates to electrical power grids, and specifically to time synchronization of sensors on the electrical power grids for the purposes of simulations.

### BACKGROUND

Electrical power grids transmit electrical power to loads such as residential and commercial buildings. Electrical grid situational awareness and modeling relies on networks of sensors over the grid. Sensors should have accurate reference times associated with measurements that the sensors perform in order to accurately evaluate and correlate measurement data grid wide. For example, calculating accurate phase differences requires accurate timing between voltage and current measurements. While some grid sensors (e.g., phasor-measurement units) do maintain very accurate timing references, many other sensors do not.

### SUMMARY

Throughout the electric grid, sensors can generally have individually precise local clocks, but the reference time of each individual clock may differ from that of the local clocks for other sensors, e.g., the clock of one sensor may drift from the clock of another sensor slowly. Some electric grid operations, measurements, or both rely on accurate time references to calculate phasor angles associated with measurements. Some sensors, such as phasor-measurement units (PMU), provide accurate enough time information to determine phasor angles. These types of sensors, however, are expensive, making implementation throughout the electric grid costly. Many other types of sensors are already present in the electric grid, but they use less accurate time reference sources, e.g., internet-based time calibration schemes that can be affected by network latency at the millisecond level.

Many sensors already present in the electric grid include circuit boards with crystal oscillators, which can maintain relatively precise time. However, the various sensors can have slight differences between their respective local time references, which can create a time offset between sensors.

The present disclosure is related to a process to account for differing timing offsets between different electric grid devices that communicate with each other. For example, each sensor with a crystal oscillator can regularly report its associated clock signal to a central server. The central server can compile the various clock signals and determine a time offset table. The central server can communicate a respective time offset value to each sensor, allowing each sensor to calibrate its time reference. In some implementations, individual electric grid components can store their own table with offsets between the individual electric grid component and other electrical grid components.

In general, innovative aspects of the subject matter described in this specification can be embodied in methods that include the actions of: receiving, by a first electric grid device, a message from a second electric grid device, the message including a first clock value associated with an oscillator of the second electric grid device; determining, based on the first clock value, a second-first device time offset between the second electric grid device and the first electric grid device; and storing the second-first device time offset in a time offset table stored at the first electric grid device. Other implementations of this aspect include corresponding systems, apparatus, and computer programs, configured to perform the actions of the methods, encoded on computer storage devices.

These and other implementations can each optionally include one or more of the following features.

In some implementations, the method includes: receiving, by the first electric grid device, a second message from the second electric grid device; and translating a time stamp in the second message to a local time of the first electric grid device by adjusting a value of the time stamp based on the second-first device time offset.

In some implementations, the method includes: transmitting the second-first device time offset from the first electric grid device to the second electric grid device; receiving, at the second electric grid device and from the first electric grid device, the second-first device time offset; and updating, using the second-first device time offset, a clock of the second electric grid device.

In some implementations, the first electric grid device receives new messages periodically.

In some implementations, translating the time stamp includes adding the second-first device time offset to the value of the time stamp.

In some implementations, the second electric grid device stores another time offset table.

In some implementations, the method includes: receiving, by the first electric grid device, a third message from a third electric grid device, the third message including a second clock value associated with an oscillator of the third electric grid device; determining, based on the second clock value, a third-first device time offset between the third electric grid device and the first electric grid device; storing, by first electric grid device, the third-first device time offset in the time offset table stored at the first electric grid device.

In some implementations, the method includes: receiving, by the second electric grid device, a third message from a third electric grid device, the third message including a second clock signal value associated with an oscillator of the third electric grid device; determining, based on the second clock signal, a third-second device time offset between the third electric grid device and the second electric grid device; storing the third-second device time offset be in a time offset table stored at the second electric grid device; sending, from the first electric grid device, the second-first device time offset to a time coordinating device; and sending, from the second electric grid device, the third-second device time offset to the time coordinating device.

In some implementations, determining the second-first device offset time includes: obtaining a local clock value from a reference clock of the first electric grid device; and determining a difference in time between the local clock value and the first clock value to obtain the second-first device time offset.

Particular implementations of the subject matter described in this specification can be implemented so as to realize one or more of the following advantages. For example, preexisting sensors throughout the electric grid can be synchronized in time without having to add or replace additional hardware. Electric grid monitoring and modeling can benefit from more accurate time references coming from sensors connected to the electric grid. For example, improved accuracy in reference time keeping by more electric grid sensors can improve the accuracy of any electric grid monitoring, simulation, or control system that relies on real-time sensor data. For instance, central electric grid monitoring and control systems may rely on correlating time based measurements of power, voltage, and/or current at different locations in an electric grid. Such correlations more accurately represent the behaviors of the grid at a specific point in time when the reference time values of each measurement are more accurate and more precisely synchronized. This also enables more accurate real-time operational decisions and control of the grid.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1A illustrates one example of an electric grid sensor system for time synchronization between sensors on an electrical power grid.

FIG. 1B illustrates another example of an electric grid sensor system for time synchronization between sensors on an electrical power grid.

FIG. 2 illustrates an example of a process for applying a time offset value by an electric grid sensor.

FIG. 3 shows an example of a process using an offset value between electric grid devices on an electrical power grid.

### DETAILED DESCRIPTION

In general, simulations of the electrical power grid can incorporate measurements of current, voltage, phasor angle, and time taken by sensors on the electrical power grid. Some sensors on the electrical power grid can precisely keep track of time, however, the local reference time of each sensor may not be accurately synchronized with that of other sensors, e.g., there is likely a time offset or time difference between the local clocks of different sensors. The concepts disclosed herein can allow time synchronization between sensors using time offsets to adjust time stamps associated with messages and measurements of electric grid sensors.

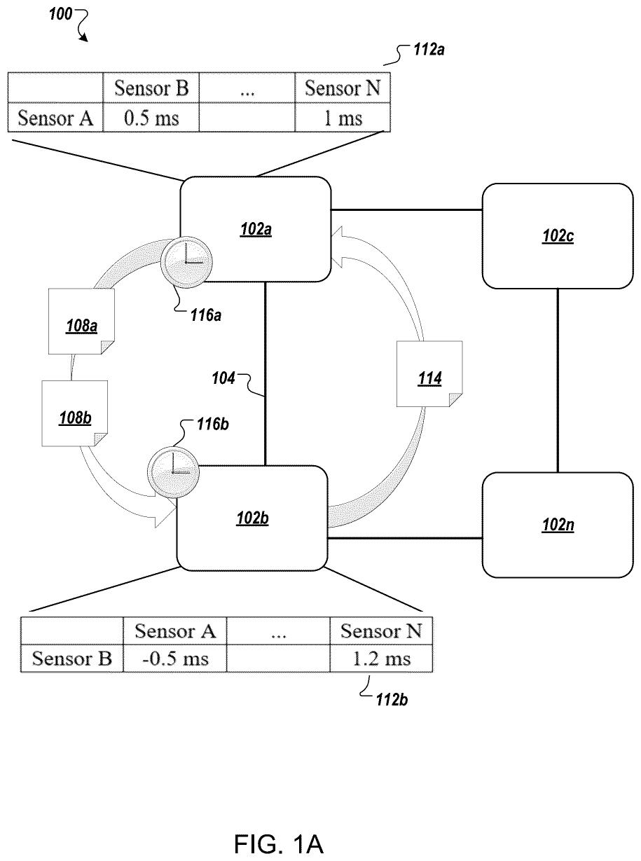

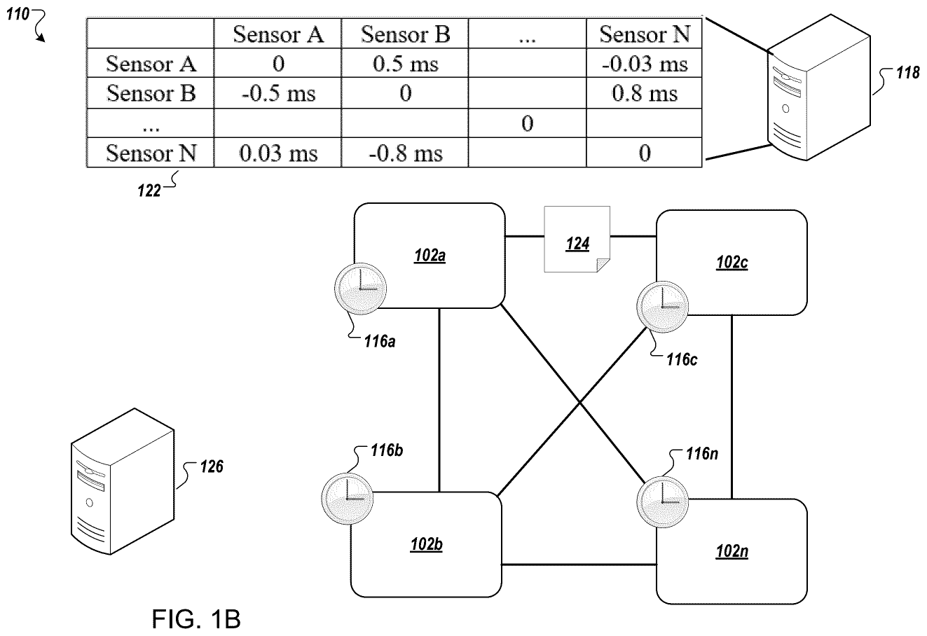

FIG. 1A shows an example of an electric grid sensor system 100. The electric grid sensor system 100 includes sensors 102a, 102b, 102c, . . . 102n. The sensors 102a-n can measure and store electrical circuit properties, such as voltage, current, power, resistance, conductivity, and time of measurement. The sensors 102a-n can be connected at different locations on the electrical grid 104 to measure electrical properties at those locations.

Each sensor 102a-n can have a precise clock, such as a crystal oscillator. The clocks, e.g., 116a and 116b, may have slight offsets between them, e.g., ˜ milliseconds. Each clock can maintain a local time reference, such as date and time, to manage operation of each sensor and track the timing of individual measurements. For example, a sensor 102a can be programmed to take a voltage measurement periodically or transmit data at regular intervals. Tracking timing of measurements can allow for coordination and synchronization of measurement data between different sensors 102a-n. For example, sensors 102a and 102b can both measure voltage values but at different locations on the electric grid. Having the time that each measurement was performed at each sensor 102a and 102b can allow for analysis of the voltage phase difference at different locations of the electrical grid 104.

The sensors can synchronize internal clock times by sending messages between each other. For example, sensor 102a can send a message 108a to sensor 102b. The message 108a can include a clock signal value associated with the clock 116a, e.g., the crystal oscillator and clock/counter circuit, of sensor 102a. The clock signal value can include a timestamp or time value of the local clock 116a of the sensor 102a sending the message 108a at the time the message was sent, the time measurement was obtained, or both. Sensor 102b can use the time value from sensor 102a to determine the time offset, e.g., difference in perceived local times, between sensors 102a and 102b. In some implementations, messages can include measurements of electrical properties of the electric grid at a particular sensor, including, but not limited to, current, voltage, power, resistance, and conductivity. Sensor 102b can store this time offset and other information in the messages in a table 112b. In some implementations, the sensors 102a-n use protocols, such as radio frequencies (RF) (e.g., Wi-Fi, cellular, 4G, 5G, LTE), power line communication (PLC), or another communication medium or using another communication protocol.

In some implementations, the sensors 102a-n determine their respective time offsets by communicating through messages with time stamps. For example, sensor 102a can send a message 108a to sensor 102b, the message 108a including a clock signal value, e.g., a time stamp. Sensor 102b can calculate a difference between the local time of receipt of message 108a and the time stamp in the message. The calculated difference can be the time offset of sensor 102b relative to sensor 102a, e.g., the second-first device time offset, where the first sensor receives the message and stores the time offset relative to a second sensor.

In some implementations, the sensors 102a-n calculate the time offsets between one another by using known quantities about the electrical grid when sending signals. Such implementations can be compatible with power line communication (PLC) when calibrating transmission times. For example, given the locations and electrical properties of the electrical grid 104 between two sensors 102a and 102b, sensor 102b can determine how long a signal sent from 102a should take to reach sensor 102b. For example, the signal velocity, the dielectric constant, magnetic permeability, impedance, inductance, capacitance, another electrical properties can determine the signal velocity of an electric signal propagating from sensor 102a to sensor 102b. The signal velocity and distance between sensors 102a and 102b can determine the travel time t_{AB} between sensors 102a and 102b. Similar transmission time corrections can be suitable for other communication methods where transmission statistics that reflect network latencies due to routing delays can predict the correction factor, e.g., average transmission times/delays.

By comparing the travel time to the difference in time stamps in messages sent between sensors 102a and 102b, the sensors can determine a time offset Δt. For example, sensor 102a can send a message 108a with a timestamp t_{A} at which a signal is detected. Sensor 102b can detect the signal recorded at a time stamp t_{B}. The difference in time stamps, t_{B}−t_{A}, can be greater than, less than, or equal to the travel time t_{A}. The first-second device time offset, e.g., (t_{B}−t_{A})−t_{AB}=Δt, can reflect how out of sync sensors 102a and 102b are. For example, sensor 102b can have a negative time offset Δt relative to sensor 102a, e.g., the signal appears to have reached sensor 102b faster than the travel time t_{AB} would have predicted. In another example, sensor 102b can have a positive time offset Δt relative to sensor 102a, e.g., the signal appears to have a lag because the difference in time stamps (t_{B}−t_{A}) is greater than the travel time t_{AB}. The sign of the time offset can be positive or negative, and the time offset between two sensors will be the opposite of each other, depending on from which perspective, e.g., that of sensor 102a or 102b, the time offset is determined. For example, sensor 102b can have a time offset Δt relative to sensor 102a, while sensor 102a can have a second-first device time offset −Δt relative to sensor 102b.

In some implementations, the sensors use a universal time reference to calculate the time offsets between various sensors. For example, sensor A could measure a time t_{A}, which has a time offset Δt_{A} from universal time t, e.g., t_{A}−t=Δt_{A}. Similarly, sensor B could measure a time t_{B}, which has a time offset Δt_{B} from universal time t, e.g., t_{B}−t=Δt_{B}. The sensors A and B can determine a relative time offset using the following steps. At absolute time t=t₀, sensor A can send sensor B a message with a timestamp of t₀+Δt_{A}. After the time it takes for the message to travel from sensor A to sensor B, e.g., travel time t_{AB}, the message arrives at sensor B at absolute time t₀+t_{AB}. Ignoring the time taken to process the message, sensor B records receiving the message at a timestamp t₀+t_{AB}+Δt_{B}. Sensor B can calculate a difference ΔT₁=t_{AB}+Δt_{B}−Δt_{A}. Then sensor B can send sensor A a message in a similar manner. Sensor A can then calculate another difference ΔT₂=t_{BA}+Δt_{A}−Δt_{B}.

Then the sensors A and B can proceed in multiple ways. In some implementations, the sensors can assume that the travel times from sensor A to sensor B t_{AB} and from sensor B to sensor A t_{BA} are equivalent. Then the sensors can communicate the calculated differences, and either sensor A or B or both can compute the absolute time offsets: ±(Δt_{A}−Δt_{B})=±(ΔT₂−ΔT₁)/2. In some implementations, the travel times from one sensor to another might not be exactly equal due to the method of transmitting data, e.g., using an ethernet. In such implementations, the computations could account for an estimated error in the accuracy of travel time estimates.

In some implementations, the travel times t_{AB} and t_{BA} can be independently estimated. If the travel time depends on the direction of travel, e.g., t_{AB}+Δd=t_{BA}, then the absolute difference between time offsets can be calculated as Δt_{B}−Δt_{A}=(ΔT₂−ΔT₁+Δd)/2.

In some implementations, each sensor can compile its own time offset table. For example, sensor 102a can compile a table 112a, which includes the time offsets between sensor 102a and sensors 102b-n. As another example, sensor 102b can compile a table 112b, which includes the time offsets between sensor 102b and sensors 102a,c-n. Time offsets can be positive or negative, and the time offset stored between two sensors will have opposite values in each time offset table. For example, sensor 102a can store a first-second time offset between sensors 102a and 102b as 0.5 ms, while sensor 102b can store a second-first time offset between sensors 102a and 102b as −0.5 ms.

The sensors can communicate the values of their respective time offset tables to other sensors. In some implementations, the sensors use this communication to update their respective clocks. For example, sensor 102b can send a message 114 to sensor 102a. The message 114 can include the first-second device time offset between sensors 102a and 102b that is stored in table 112b. Accordingly, sensor 102a can receive the message 114 and update its clock 116a using the first-second device time offset between sensors 102a and 102b.

In some implementations, the sensors do not update their respective clocks, but rather translate time stamps of measurements using the time offsets. For example, sensor 102a can send the first message 108a, which includes the clock signal value associated with the clock 116a, e.g., the crystal oscillator and clock circuit, to sensor 102b. Sensor 102b can determine the first-second device time offset between sensors 102a and 102b, and store the first-second device time offset in table 112b. Then, sensor 102a can send a second message 108b, which includes a time stamp. Sensor 102b can translate this time stamp to a local time of sensor, e.g., the time according to sensor 102b, based on the first-second device t time offset between sensors 102a and 102b stored in table 112b. Translating the time stamp rather than updating the clock 116b of sensor 102b can be useful for calculation purposes, e.g., simulations of the electrical power grid that rely on real-world measurements.

In some implementations, translating the timestamp can include adding or subtracting a time offset between a pair of sensors when the pair of sensors send messages to each other. For example, when sensor 102a sends a message 108a with a current measurement to sensor 102b, it can add the first-second device time offset Δt of sensor 102b relative to sensor 102a (or equivalently subtract the time second-first device offset −Δt of sensor 102a relative to sensor 102b from) to the time of measurement of the current. For example, sensor 102a can add 0.5 ms to the times of measurements of different electrical properties sent in messages to sensor 102b, while sensor 102b can subtract 0.5 ms to the times of measurements sent in messages to sensor 102a. In this case, neither sensor 102a nor 102b update their respective clocks 116a and 116b, but rather they tailor timestamps in messages sent to other sensors based on the time offset relative to the other sensors.

In some implementations, the sensors can access a centralized time offset table. With reference to FIG. 1B, the electric grid sensor system 110 can include sensors 102a-n, which are connected to different locations on the electrical power grid 104. Each sensor 102a-n can have a clock 116a-n, which can have a unique local time, e.g., have time offsets relative to other sensors.

The sensors 102a-n can communicate with a time coordinating device, e.g., server 118, sending their respective clock signal values. In some implementations, the sensors 102a-n communicate to the server 118 over protocols including, but not limited to, Wi-Fi, radiofrequency (RF), in power line communication (PLC). The sensors 102a-n can receive signals from the server 118 over such protocols, as well. In some implementations, the sensors 102a-n can have transceivers for communicating with the server 118.

The server 118 can compile a centralized time offset table 122. For example, for every sensor 102a-n that communicates with the server 118, the server 118 can add a row and a column in a matrix corresponding to the sensor. When determining the sign of the time offset Δt between two sensors, the server 118 can determine which sensor's perspective to use, e.g., the “perspective” sensor. For example, the rows of the matrix of the centralized time offset table 122 can correspond to the sensor from whose perspective the offset is being determined. The columns can correspond to the sensor that has a time offset Δt relative to the perspective sensor. The value for the time offset Δt between the same sensor is zero, e.g., the element of the matrix corresponding to the time offset between sensor 102a and 102a is zero. The centralized time offset table 122 can store values for the time offsets between two different sensors with opposite values. For example, the matrix element corresponding to the row for sensor A and the column for sensor B can have the value −0.5 ms, while the matrix element corresponding to the row for sensor B and the column sensor A can have a value 0.5 ms.

The sensors 102a-n can translate their respective time stamps after accessing the appropriate value stored in the centralized time offset table 122. For example, before sending a message 124 to sensor 102c, sensor 102a can access the centralized time offset table 112 to determine the time offset between sensors 102a and 102c. The message 124 can include a time stamp adjusted by the time offset between sensors 102a and 102c. In some implementations, the message can include measurements of electrical properties at the sensor that took the measurement.

In some implementations, the sensors do not translate their time stamps when communicating with other sensors. Rather, the sensors 102a-n add the appropriate time offset value from the centralized time offset table 122 before sending data collected by the sensors 102a-n to another server 126, which compiles sensor data.

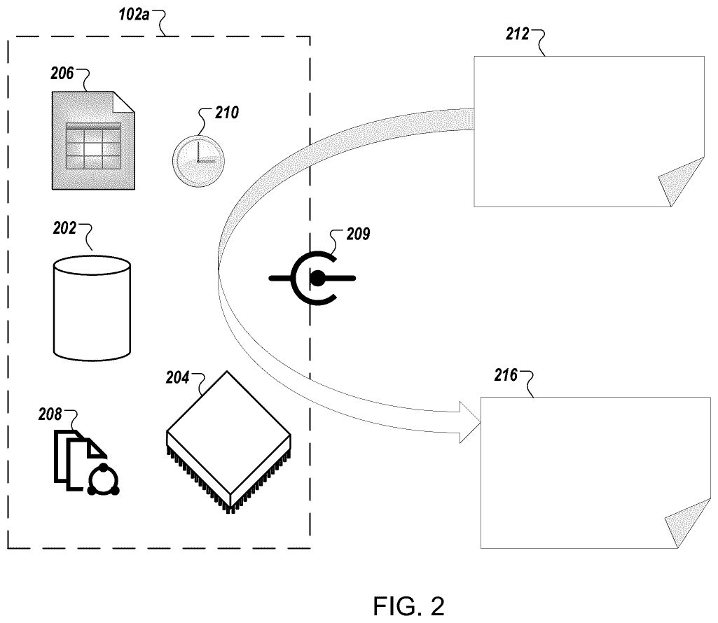

FIG. 2 illustrates how a sensor, such as sensor 102a, applies a time offset value. In some implementations, using the time offset value can include updating the clock value, translating a time stamp, storing the time offset value, or a combination thereof. For example, sensor 102a can receive a message 212 including time information 214. In some implementations, time information 214 is a clock signal value, a time stamp, or a time offset. Depending on what type of time information 214 the message 212 includes, the sensors 102a-n can respond differently. In some examples, sensor 102a can have memory 202 (e.g., instruction registers, random access memory, read only memory, flash memory, etc.), a processor 204 (e.g., one or more microprocessors or microcontrollers), a time offset table 206, a communication interface 209, an internal clock 210 and firmware 208, which includes instructions to process time information 214 according to processes disclosed herein. The communication interface can be a network communication interface including, but not limited to, a PLC transceiver, a cellular communication radio, or WiFi radio. The internal clock 210 can include a local oscillator (e.g., crystal oscillator) and clock circuitry such as a counter configured to maintain a local time at the sensor.

In some implementations, the sensor 102a can receive the message 212, which can include a clock signal value associated with the oscillator of another sensor. Consequently, sensor 102a can obtain a local clock value from a reference clock of a different sensor. The processor 204 can follow the instructions in firmware 208 to determine a time offset between the sensor 102a and the other sensor, based on the clock signal. For example, the processor 204 could execute firmware 208 to calculate the time offset Δt as a function of time information 214 and the time according to an internal clock 210 of sensor 102a. Then the sensor 102a can store the time offset Δt in the time offset table 206.

In some implementations, the sensor 102a adjusts timestamps in messages, rather than update its own internal clock 210. For example, the firmware 208 can have instructions that include adjusting the timestamp by adding or subtracting values from the time offset table 206 two timestamps of measurements sent in messages 216.

In a first example, the sensor 102a can translate time stamps from messages sent from other sensors using the time offset table 206. For example, sensor 102a can receive a message 212 that includes time information 214 that includes a time stamp. Sensor 102a can translate the time stamp to a local time by adjusting the value of the time stamp based on the appropriate time offset 218, e.g., the time offset between sensor 102a and the recipient sensor, stored in time offset table 206. Sensor 102a can send messages 216 that include the translated time stamp, e.g., the time stamp of time information 214 plus the time offset 218.

As a second example, sensor 102a can use time information 214 to update its clock. For example, sensor 102a can receive a message 212 with time information 214 that includes the time offset between sensor 102a and another sensor. Sensor 102a can update its internal clock 210 using the time offset so that it agrees with the local time of the sensor that sent the message 212.

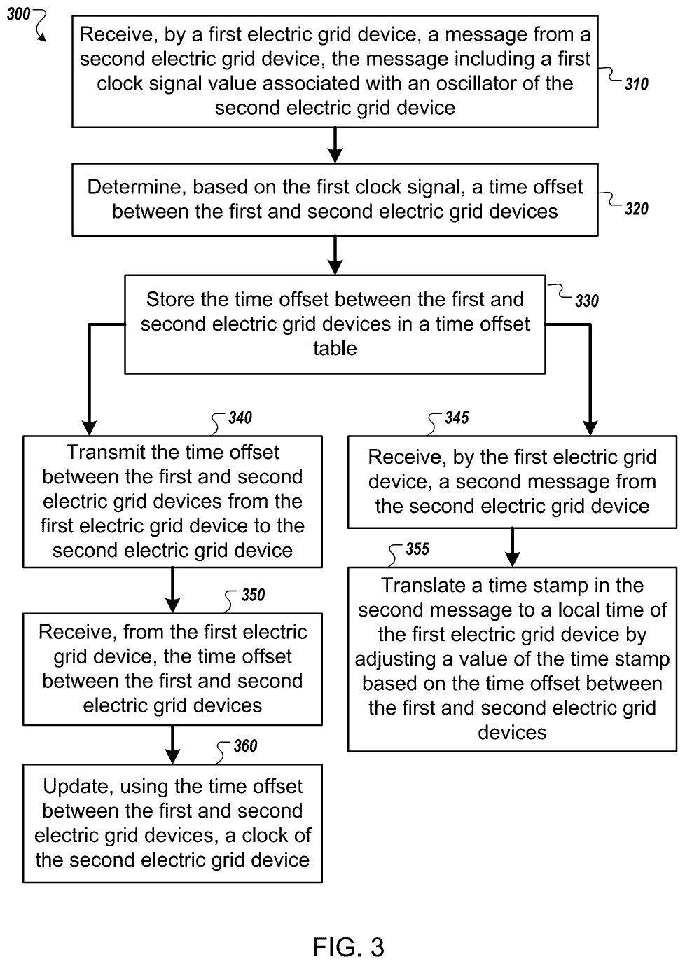

FIG. 3 is a flow diagram of a process 300 for using the time offset value between electric grid devices to synchronize sensors in an electrical power grid. For example, the process 300 can be performed by sensors 102a-n from the electric grid sensor system 100.

A first electric grid device can receive a message from a second electric grid device, the message including the first clock signal associated with an oscillator of the second electric grid device (310). In some implementations, the oscillator is a crystal oscillator, which determines the time of the clock on the second electric grid device. In some implementations, the message includes measurements of electrical properties at the second electric grid device, with timestamps determined by the oscillator of the second electric grid device. The first electric grid device can receive the message over various protocols, such as Wi-Fi, radiofrequency, and power line communication.

The first electric grid device can determine, based on the first clock signal, a second-first device time offset between the first and second electric grid devices (320). In some implementations, the determining can include calculating the second-first time offset as a function of the first clock signal in relation to a local clock value of the first device at the time the message is received. In some implementations, the time second-first device offset can be adjusted to account for electrical properties of the electric grid devices in the electrical power grid.

The first electric grid device can store the second-first device time offset between the first and second electric grid devices in a time offset table (330). For example, the first device can add the computed second-first device time offset to a time offset table stored locally on the first device. In some implementations, the first device can send the computed second-first device time offset to the second electric grid device and the second electric grid device can store the time offset table. In some implementations, the first electric grid device can receive multiple messages from different electric grid devices, determine the respective offsets between the first electric grid device and the other electrically devices, and store the respective offsets in the time offset table.

In some implementations, the first electric grid device sends the computed second-first device time offset to a time coordinating device (e.g., a central server). The time coordinating device can store and manage time offsets between a group of different electric grid sensors.

In some implementations, the process 300 continues, depending on whether the electric grid devices in the electrical grid are updating their respective clocks to a global time reference, translating time stamps and messages the electric grid devices send, or both. In some implementations, the first electric grid device transmits the second-first device time offset between the first and second electric grid devices to the second electric grid device (340).

The second electric grid device receives, from the first electric grid device, the second-first device time offset between the first and second electric grid devices (350). In some implementations, the electric grid devices have transceivers receiving and transmitting information to one another.

The second electric grid device can update its clock using the second-first device time offset between the first and second electric grid devices (360). In some implementations, updating the clock of the second electric grid device can include adding or subtracting the second-first device time offset between the first and second electric grid devices.

Additionally or alternatively, the first electric grid device can translate timestamps in messages sent to the second electric grid device. In some implementations, the first electric grid device can receive a second message the second electric grid device (345). The second message can include a time stamp of the measurement taken by the second electric grid device. With the timestamp in the second message, the first electric grid device can determine how to appropriately translate the time stamp in messages sent to the second electric grid device.

The first electric grid device can translate the time stamp in the second message to a local time of the first electric grid device by adjusting the value of the time stamp based on the second-first device time offset between the first and second electric grid devices (355). In some implementations, adjusting the value time stamp can include adding the second-first device time offset between the first and second electric grid devices to the local time determined by the clock of the first electric grid device.

In some implementations, the process 300 can include additional steps, fewer steps, or some of the steps can be divided into multiple steps. For example, the first electric grid device can periodically receive messages from the second electric grid device, which could trigger either branch of process 300.

As another example, two different sensors could each perform steps 310 and 320. Each of the two different sensors could send their respective, determined time offsets, e.g., a third-first and a third-second device time offset, to a third electric grid device that compiles a centralized time offset table.

In some implementations, data collected by sensors 102a-n can be used as input data for electrical power grid simulations. The quality of electrical power grid simulations can suffer when sensors that are not synchronized in time collect the input data.

The simulations can be based on, for example, root-mean-square (RMS), power flow, positive sequence, and/or time series voltage transient analysis. The amount of data processed during each simulation can depend on the size and framework of the distribution feeder that is being evaluated. The simulation can analyze predicted effects for all connections to the affected distribution feeder and all components of the affected distribution feeder. Thus, the complexity of simulations can vary depending on construction of the distribution feeder.

Simulations can output analysis the expected operation of the power grid when empirical historical data is available. The empirical historical data can include historical electrical grid characteristics based on, for example, measurements, calculations, estimates, and interpolations. The characteristics can include, for example, load, voltage, current, power factor, and the time of measurement. The empirical historical data can represent power grid operation of multiple interconnected components within a designated geographical area. The empirical historical data can represent average electrical grid operating characteristics over a period of time, e.g., multiple weeks, months, or years.

This disclosure generally describes computer-implemented methods, software, and systems for electrical power grid visualization. A computing system can receive various electrical power grid data from multiple sources. Power grid data can include different temporal and spatially dependent characteristics of a power grid. The characteristics can include, for example, power flow, voltage, power factor, feeder utilization, and transformer utilization. These characteristics can be coupled; for example, some characteristics may influence others and/or their temporal and spatial dependence may be related.

Data sources can include satellites, aerial image databases, publicly available government power grid databases, and utility provider databases. The sources can also include sensors installed within the electrical grid by the grid operator or by others, e.g., power meters, current meters, voltage meters, or other devices with sensing capabilities that are connected to the power grid. Data sources can include databases and sensors for both high voltage transmission and medium voltage distribution and low voltage utilization systems.

The data can include, but is not limited to, map data, transformer locations and capacities, feeder locations and capacities, load locations, or a combination thereof. The data can also include measured data from various points of the electrical grid, e.g., voltage, power, current, power factor, phase, and phase balance between lines. In some examples, the data can include historical measured power grid data. In some examples, the data can include real-time measured power grid data. In some examples, the data can include simulated data. In some examples, the data can include a combination of measured and simulated data.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any system or on the scope of what may be claimed, but rather as descriptions of features that may be specific to particular implementations of particular systems. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art.

For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. An electric grid timing coordination method comprising:
receiving, by a first electric grid device, a message from a second electric grid device, the message including a first clock value associated with an oscillator of the second electric grid device;
determining, based on the first clock value, a second-first device time offset between the second electric grid device and the first electric grid device; and
storing the second-first device time offset in a time offset table stored at the first electric grid device.

2. The method of claim 1 comprising:
receiving, by the first electric grid device, a second message from the second electric grid device; and
translating a time stamp in the second message to a local time of the first electric grid device by adjusting a value of the time stamp based on the second-first device time offset.

3. The method of claim 1 comprising:
transmitting the second-first device time offset from the first electric grid device to the second electric grid device;
receiving, at the second electric grid device and from the first electric grid device, the second-first device time offset; and
updating, using the second-first device time offset, a clock of the second electric grid device.

4. The method of claim 1, where the first electric grid device receives new messages periodically.

5. The method of claim 2, where translating the time stamp comprises adding the second-first device time offset to the value of the time stamp.

6. The method of claim 1, where the second electric grid device stores another time offset table.

7. The method of claim 1, comprising:
receiving, by the first electric grid device, a third message from a third electric grid device, the third message including a second clock value associated with an oscillator of the third electric grid device;
determining, based on the second clock value, a third-first device time offset between the third electric grid device and the first electric grid device;
storing, by first electric grid device, the third-first device time offset in the time offset table stored at the.

8. The method of claim 1, comprising:
receiving, by the second electric grid device, a third message from a third electric grid device, the third message including a second clock signal value associated with an oscillator of the third electric grid device;
determining, based on the second clock signal, a third-second device time offset between the third electric grid device and the second electric grid device;
storing the third-second device time offset be in a time offset table stored at the second electric grid device;
sending, from the first electric grid device, the second-first device time offset to a time coordinating device; and
sending, from the second electric grid device, the third-second device time offset to the time coordinating device.

9. The method of claim 1 where determining the second-first device offset time comprises:
obtaining a local clock value from a reference clock of the first electric grid device; and
determining a difference in time between the local clock value and the first clock value to obtain the second-first device time offset.

10. An electric grid sensor comprising:
computer memory comprising more instructions for performing electric grid time synchronization;
a local clock circuit;
a network communication interface; and
one or more processors in electrical communication with the network communication interface, the local clock circuit; and the computer memory, the one or more processors configured to execute the one or more instructions to perform operations comprising:
receiving a message from a second electric grid device, the message including a first clock value associated with an oscillator of the second electric grid device;
determining, based on the first clock value, a second-first device time offset between the second electric grid device and the electric grid sensor; and
storing the second-first device time offset in a time offset table stored in the computer memory.

11. A non-transitory computer readable storage medium storing instructions that, when executed by at least one processor, cause the at least one processor to perform operations comprising:
receiving, by a first electric grid device, a message from a second electric grid device, the message including a first clock value associated with an oscillator of the second electric grid device;
determining, based on the first clock value, a second-first device time offset between the second electric grid device and the first electric grid device; and
storing the second-first device time offset in a time offset table stored at the first electric grid device.

12. The non-transitory computer readable storage medium of claim 11, where the operations comprise:
receiving, by the first electric grid device, a second message from the second electric grid device; and
translating a time stamp in the second message to a local time of the first electric grid device by adjusting a value of the time stamp based on the second-first device time offset.

13. The non-transitory computer readable storage medium of claim 11, where the operations comprise:
transmitting the second-first device time offset from the first electric grid device to the second electric grid device;
receiving, at the second electric grid device and from the first electric grid device, the second-first device time offset; and
updating, using the second-first device time offset, a clock of the second electric grid device.

14. The non-transitory computer readable storage medium of claim 11, where the first electric grid device receives new messages periodically.

15. The non-transitory computer readable storage medium of claim 12, where translating the time stamp comprises adding the second-first device time offset to the value of the time stamp.

16. The non-transitory computer readable storage medium of claim 11, where the second electric grid device stores another time offset table.

17. The non-transitory computer readable storage medium of claim 11, where the operations comprise:
receiving, by the first electric grid device, a third message from a third electric grid device, the third message including a second clock value associated with an oscillator of the third electric grid device;
determining, based on the second clock value, a third-first device time offset between the third electric grid device and the first electric grid device;
storing, by first electric grid device, the third-first device time offset in the time offset table stored at the first electric grid device.

18. The non-transitory computer readable storage medium of claim 11, where the operations comprise:
receiving, by the second electric grid device, a third message from a third electric grid device, the third message including a second clock signal value associated with an oscillator of the third electric grid device;
determining, based on the second clock signal, a third-second device time offset between the third electric grid device and the second electric grid device;
storing the third-second device time offset be in a time offset table stored at the second electric grid device;
sending, from the first electric grid device, the second-first device time offset to a time coordinating device; and
sending, from the second electric grid device, the third-second device time offset to the time coordinating device.

19. The non-transitory computer readable storage medium of claim 11, where determining the second-first device offset time comprises:
obtaining a local clock value from a reference clock of the first electric grid device; and
determining a difference in time between the local clock value and the first clock value to obtain the second-first device time offset.
